(19) United States
(12) Patent Application Publication
(10) Pub. No.: US 2016/0095282 A1
(43) Pub. Date: Apr. 7, 2016

(54) FLUORINATED FILM

(71) Applicant: ARKEMA FRANCE, Colombes (FR)

(72) Inventors: Samuel DEVISME, Rouen (FR); Barbara WIEGERT(FORMALLY RAMFEL), Barc (FR); Thomas FINE, Lyon (FR); Anthony BONNET, Saint Laurent de Mure (FR)

(21) Appl. No.: 14/785,969

(22) PCT Filed: Apr. 22, 2014
(86) PCT No.: PCT/FR2014/050965

§ 371 Date: Oct. 21, 2015

(30) Foreign Application Priority Data
Apr. 23, 2013 (FR) 1353672
Apr. 3, 2014 (FR) 1452980

(51) Int. Cl. A01G 9/14; E04F 13/00; B32B 27/30; B32B 27/20; C08L 27/16; B32B 27/08

(52) U.S. Cl. CPC A01G 9/1438; C08L 27/16; B32B 27/08; B32B 27/304; B32B 27/20; E04F 13/002; B32B 2264/0214; B32B 2307/558; B32B 2419/06

(57) ABSTRACT

The present invention relates to a fluorinated composition and a fluorinated film having properties that make it suitable for use outside, especially in the agricultural sector. The film according to the invention is a single-layer polymer film comprising a polyvinylidene fluoride (PVDF) matrix and at least one impact modifier having a polyorganosiloxane core and at least one thermoplastic shell, in which the weight content of impact modifier varies between 2.5% and less than 40%. According to one embodiment variant, the invention relates to multilayer films comprising at least one layer of said fluorinated film and at least one layer of unmodified PVDF.

The present invention relates to a fluorinated film having properties which render it suitable for use externally, in particular in the agricultural field, as greenhouse covering films (or greenhouse films) or in the form of translucent films to be inserted into the body of building, in particular agricultural buildings. The film according to the invention comprises a polyvinylidene fluoride matrix and at least one impact modifier.

A greenhouse is a structure which can be completely enclosed, intended in general for agricultural production, by shielding food-producing crops from the elements in order to accelerate the growth thereof or to produce them independently of the seasons. The covering is translucent and generally made of glass but also of rigid or flexible plastic (for example: polyethylene film, semirigid PVC sheets), generally treated in order to withstand ultraviolet radiation. This film can be reinforced in order to increase its tear strength.

Generally, greenhouse films have to exhibit multiple properties:
mechanical, such as: tear strength in a temperature range from −20° C. to +60° C., creep strength, drawability;
optical, such as transmission of visible light, resistance to UV rays;
of chemical resistance, in particular to pesticides;
of durability: resistance to wet heat and to cold;
of thermal resistance: high ability to reflect infrared rays in the greenhouse overnight while keeping the thermal energy in the inside.

Optionally, greenhouse films can exhibit additional properties:
of fire resistance;
antifogging properties;
of resistance to soiling.

It is known to employ fluoropolymers, in particular based on vinylidene fluoride, to manufacture monolayer films for agricultural applications. Monolayer films based on PVDF (polyvinylidene fluoride) or on VDF/HFP (vinylidene fluoride/hexafluoropropylene) copolymers, obtained by film blowing or by the cast film technique, exhibit good mechanical, optical, chemical resistance and durability properties, with the result that these are good candidates for the agricultural greenhouse application. However, the tear strength of these films is inadequate, in particular in the extrusion direction (MD).

The document WO 2011/121228 describes multilayer fluorinated films comprising at least 3 layers, including a layer A made of a first vinylidene fluoride copolymer having a crystallization temperature TcA and a layer B made of a second vinylidene fluoride copolymer having a crystallization temperature TcB, TcA being greater than TcB, the layers A and B being alternating, the layer A being placed on the outside and the layer B being placed between two layers A. The tear strength of these films was significantly improved, with respect to the known fluorinated films; however, it remains inadequate at low temperature.

It would thus be desirable to have available fluorinated films for application as greenhouse covering which, in addition to the general characteristics set out above, exhibit good tear strength properties within a temperature range extending from −20° C. to +60° C.

Other applications relate to the roofs of buildings, in particular livestock buildings, which have to allow light to diffuse, thus contributing to the wellbeing of the animals by a harmonious distribution of natural light.

It has now been found that, by modifying a polyvinylidene fluoridepolymer by addition of impact modifier of core-shell type, a significant improvement in the tear strength of the film, in particular at low temperature, is obtained, while retaining a level of transmission in the visible region and a level of fire resistance which are compatible with the use of the film as greenhouse covering film or, more generally, as film for agricultural buildings.

One of the subject matters of the present invention is a monolayer film made of PVDF modified by addition of at least one impact modifier of core-shell type.

Another subject matter of the invention is a multilayer film comprising at least one layer of PVDF modified with at least one impact modifier of core-shell type and at least one layer of unmodified PVDF, that is to say a PVDF which does not comprise impact modifier (hereinafter referred to as “PVDF layer”).

Another subject matter of the invention is the use of the films according to the invention as agricultural covering materials, in particular as covering materials for greenhouses or buildings.

Other characteristics and advantages of the invention will become apparent on reading the account which follows.

According to a first aspect, the invention relates to a monolayer polymer film comprising a polyvinylidene fluoride (PVDF) matrix and at least one impact modifier, in which the content by weight of impact modifier varies between 2.5% and less than 40%. The thickness of the film is located between 30 and 200 microns, preferably between 80 and 150 microns (limits included).

According to one embodiment, the content of impact modifier is greater than 5% and less than or equal to 30%.

According to one embodiment, the monolayer film according to the invention consists of a PVDF matrix and of at least one core-shell impact modifier.

The distribution of the thicknesses as a percentage of the final thickness of the structure is as follows: modified PVDF layer: 20%-95%, unmodified PVDF layer: 5%-80%, i.e. for example, for a total thickness of 30 microns and a 70/30 distribution: modified PVDF layer: 21 microns, and unmodified PVDF layer: 9 microns.

According to a second aspect, the invention relates to a multilayer film comprising at least one layer of the monolayer film described and at least one other PVDF layer. In the case of a multilayer film, the overall thickness is located between 30 and 200 microns. According to one embodiment, the multilayer film consists of a central layer of PVDF modified with a core-shell impact modifier and of two external layers made of PVDF. The latter can have the same structure or else they can have different structures.

The PVDF matrix is composed of a PVDF homopolymer or of a copolymer prepared by copolymerization of vinylidene fluoride (VDF, CH₂═CF7) with a fluorinated comonomer chosen from: vinyl fluoride; trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); or perfluoro(2,2-dimethyl-1,3-dioxole) (PDD).

Preferably, the fluorinated comonomer is chosen from chlorotrifluoroethylene (CTFE), hexafluoropropylene (HFP), trifluoroethylene (VF3) and tetrafluoroethylene (TFE), and their mixtures.

The comonomer is advantageously HFP. Preferably, the copolymer comprises only VDF and HFP.

Preferably, the fluorinated copolymers are VDF copolymers, such as VDF-HFP, comprising at least 50% by weight of VDF, advantageously at least 75% by weight of VDF and preferably at least 80% by weight of VDF. Mention may more particularly be made, for example, of the VDF copolymers comprising more than 75% of VDF and their remainder of HFP sold by Arkema under the name Kynar Flex®.

The core-shell impact modifier is provided, according to one embodiment, in the form of fine particles having a core made of elastomer (having a glass transition temperature of less than 25° C., preferably of less than 0° C., more preferably of less than −5° C., more preferably still of less than −25° C.) and at least one thermoplastic shell (comprising at least one polymer having a glass transition temperature of greater than 25° C.), The size of the particles is generally less than one micron and advantageously between 50 and 300 nm. Mention may be made, as example of core, of isoprene or butadiene homopolymers, copolymers of isoprene with at most 30 mol % of a vinyl monomer and copolymers of butadiene with at most 30 mol % of a vinyl monomer. The vinyl monomer can be styrene, an alkylstyrene, acrylonitrile or an alkyl (meth)acrylate. Another core family consists of homopolymers of an alkyl (meth)acrylate and copolymers of an alkyl (meth)acrylate with at most 30 mol % of a monomer chosen from another alkyl (meth)acrylate and a vinyl monomer. The alkyl (meth)acrylate is advantageously butyl acrylate.

The vinyl monomer can be styrene, an alkylstyrene, acrylonitrile, butadiene or isoprene. The core of the core-shell copolymer can be crosslinked in all or part. It is sufficient to add at least difunctional monomers during the preparation of the core; these monomers can be chosen from poly(meth)acrylic esters of polyols, such as butylene di(meth)acrylate and trimethylolpropane trimethacrylate. Other difunctional monomers are, for example, divinylbenzene, trivinylbenzene, vinyl acrylate and vinyl methacrylate. The core can also be crosslinked by introducing therein, by grafting or as comonomer during the polymerization, unsaturated functional monomers, such as unsaturated carboxylic acid anhydrides, unsaturated carboxylic acids and unsaturated epoxides. Mention may be made, by way of example, of maleic anhydride, (meth)acrylic acid and glycidyl methacrylate.

The shell or shells are homopolymers of styrene, an alkylstyrene or methyl methacrylate or copolymers comprising at least 70 mol % of one of these preceding monomers and at least one comonomer chosen from the other preceding monomers, another alkyl (meth)acrylate, vinyl acetate and acrylonitrile. The shell can be functionalized by introducing therein, by grafting or as comonomer during the polymerization, unsaturated functional monomers, such as unsaturated carboxylic acid anhydrides, unsaturated carboxylic acids and unsaturated epoxides. Mention may be made, by way of example, of maleic anhydride, (meth)acrylic acid and glycidyl methacrylate.

Mention may be made, as examples of Shell polymers, of polystyrene and PMMA. There also exist core-shell polymers having two shells, one made of polystyrene and the other, on the outside, made of PMMA. According to one embodiment, the impact modifier has a core made of poly(butyl acrylate) or of butyl acrylate and butadiene copolymer and a shell made of PMMA.

Advantageously, the core represents, by weight, from 70 to 98% of the core-shell polymer and the shell from 30 to 2%.

All these impact modifiers of core-shell type are sometimes referred to as soft/hard because of the core made of elastomer. There also exist other types of impact modifiers of core-shell type, such as hard/soft/hard ones, that is to say that they have, in this order, a hard core, a soft shell and a hard shell. The hard parts can consist of the polymers of the shell of the preceding soft/hard ones and the soft part can consist of the polymers of the core of the preceding soft/hard ones. Mention may be made, for example, of those consisting, in this order:
of a core made of copolymer of methyl methacrylate and ethyl acrylate,
of a shell made of copolymer of butyl acrylate and styrene,
of a shell made of copolymer of methyl methacrylate and ethyl acrylate.

There also exist other types of impact modifiers of core-shell type, such as hard (the core)/soft/medium hard ones. In comparison with the preceding ones, the difference comes from the external “medium hard” shell, which consists of two shells: the one intermediate and the other external. The intermediate shell is a copolymer of methyl methacrylate, styrene and at least one monomer chosen from alkyl acrylates, butadiene and isoprene. The external shell is a PMMA homopolymer or copolymer. Mention may be made, for example, of those consisting, in this order:
of a core made of copolymer of methyl methacrylate and ethyl acrylate,
of a shell made of copolymer of butyl acrylate and styrene,
of a shell made of copolymer of methyl methacrylate, butyl acrylate and styrene,
of a shell made of copolymer of methyl methacrylate and ethyl acrylate. Mention may be made, as example of impact modifier of core-shell type which is preferred, of acrylic-based core-shell ones, such as those of the Durastrength® range from Arkema, of the acrylic-based range Paraloïd™ EXL from Dow or else of the range of the acrylic-based Kane Ace® products from Kaneka.

According to another embodiment, the impact modifier comprises a core made of acrylate/polysiloxane copolymer and a shell made of hard resin. In this case, the core is a material of flexible rubber type prepared by polymerization of one or more vinyl monomers in the presence of a polymer of rubber type obtained from monomers such as alkyl acrylates or alkyl methacrylates, in which the alkyl group comprises from 2 to 10 carbon atoms. Polyfunctional monomers, such as divinylbenzene, ethylene dimethacrylate, triallyl cyanurate or triallyl isocyanurate, can be added during the polymerization as crosslinking agents. The polymer of rubber type thus obtained is combined with a rubber comprising polysiloxane. The elastomers thus prepared comprise at least 20% by weight of polymer of rubber type, preferably at least 40% by weight. Examples of this type of impact modifier are rubber-based grafted copolymers prepared by copolymerization by grafting a composite rubber with at least one vinyl monomer, in which the composite rubber comprises from 5 to 95% by weight of polysiloxane-based rubber and from 5 to 95% by weight of a poly(acryl (meth)acrylate) rubber. The size of the particles of these impact modifiers varies between 0.01 and 1 micron. Products of this type are sold by Mitsubishi Rayon under the reference Metablen® S-2001.

According to another embodiment, the impact modifier is composed of a poly(organosiloxane) core and of a shell of thermoplastic resin. The organic groups of the poly(organosiloxane) cores are preferably alkyl or vinyl radicals comprising between 1 and 18 carbons, advantageously between 1 and 6 carbons, or aryl radicals or hydrocarbons which are substituted. The poly(organosiloxane) comprises one or more of these groups. The siloxanes have a variable degree of functionalization which defines the degree of crosslinking of the poly(organosiloxane). Preferably, the mean degree of functionalization is between 2 and 3, thus forming a partially crosslinked core. The shell is formed of polymers or copolymers resulting from monomers such as alkyl acrylates or methacrylates, acrylonitrile, styrene, vinylstyrene, vinyl propionate, maleimide, vinyl chloride, ethylene, butadiene, isoprene and chloroprene. Preferably, the shell is composed of styrene or of alkyl acrylate or methacrylate, the alkyl having between 1 and 4 carbons. The fraction of the core represents between 0.05 and 90% by weight of the particles, preferably between 60 and 80% by weight. The size of the particles is between 10 and 400 nm. This impact modifier can also be provided in the form of a core surrounded by 2 successive shells. The description of the core and of the external shell remains identical to that of the silicone-comprising impact modifiers having a single shell presented above. The intermediate shell consists of a poly(organosiloxane) different from that of the core but chosen from the same composition family. Mention may be made, as example of impact modifier of this type, of the products of the Genioperl® range from Wacker Silicones.

The monolayer film according to the invention can comprise at least one additive chosen from: matifying agents, infrared reflecting agents, opacifying agents, plasticizers or pearlescent pigments.

According to another aspect, the invention relates to processes for the preparation of films described above. According to one embodiment, the PVDF/core-shell mixtures are obtained melt compounding techniques known to a person skilled in the art, such as the BUSS or the twin-screw technique. According to another embodiment, the PVDF/core-shell mixtures are prepared by mixing the respective latexes. The films are subsequently obtained by film blowing or by the cast film technique, these techniques advantageously making it possible to obtain very wide films. The films can be extruded at a temperature of between 200 and 280° C. The blow ratio should be between 1.2 and 4, preferably between 1.5 and 3. The draw ratio should for its part be between 2 and 15, preferably between 5 and 10.

According to another aspect, the invention relates to the use of the monolayer film or of the multilayer film comprising a layer of said monolayer film as agricultural greenhouse covering material. The use of a layer of modified fluoropolymer according to the invention in this application makes it possible to increase the durability of the covering film and its tear strength without other additions.

According to another aspect, the invention relates to the use of the monolayer film or of the multilayer film comprising at least one layer of said monolayer film as material for the manufacture of films for the roof and/or facades of buildings, in particular agricultural buildings, such as livestock buildings. These greenhouse films then exhibit the advantage of having an improved durability combined with an excellent transparency to UV radiation.

### Example of Structures

The extrusion compounds are produced according to the rules of the art on a corotating twin-screw extruder equipped with a die, the temperature of which is set at 240° C. The films are subsequently produced by film blowing on a 5-layer laboratory line having a pancake die (diameter 50 mm, gap 1.2 mm). The drawing rate is 3 m/min and the blow-up ratio (BUR) is 2.8. The thickness of all the films is set at 100 m.

### Materials of the Study

PE: LDPE Exxon LD165BW1, MI (190° C., 2.16 kg)=1
PVDF: a copolymer of vinylidene fluoride and RFT having an MFR of 5 g/10 min (230° C.; 5 kg), a melting point (Tm) of 142° C. and a Young's modulus of 650 MPa at 23° C. The Tm was measured by DSC or differential scanning calorimetry. The elastic moduli were measured according to the standard ISO 178.
CS: Genioperl® P52 from Wacker comprising a polydimethylsiloxane core coated with a polymethyl methacrylate shell. The diameter of these particles is of the order of 150 nm.

The tests carried out are as follows:
Characterization of the cold tear strength: a film is placed in a frame and placed under a tension of 1N. The test consists in dropping, from a height of 30 cm, a striker having a conical tip and with a weight of 1 kg. This test is carried out in a climate-controlled chamber and the ductile or brittle nature of the deformation is deduced from the failure profile observed on the film after perforation.
The optical properties of the films were determined by measuring the transmittance in the visible region, and also the level of haze. The transmittance of the films was evaluated between 400 nm and 740 nm according to the standard ASTM D1003 with an illuminant C under 2° using a CM-3610d spectrocolorimeter from Minolta.

The fire resistance of the films is determined according to the standard NF P92-503 which runs onto a classification of the films on a scale ranging from M0 (noncombustible) to M5 (very readily flammable). The test consists in exposing the film to a flame and in measuring:
the afterflame time after the source of ignition has been removed;
the length and the width of burnt film;
the presence of flaming drips.

In the resistance range in which PVDF films occur, an afterflame time of greater than 5 seconds results in a downgrading by one level (from M1 to M2). Likewise, the presence of flaming drips, an average length destroyed of greater than 35 cm or an average width destroyed of greater than 9 cm each results in an additional downgrading.

These results are presented in table 1.

These results show that the addition of core-shell impact modifier to the PVDF matrix makes it possible to significantly improve the tear strength of the fluorinated film in comparison with the film devoid of impact modifier.

This improvement in the mechanical properties is accomplished with a limited impact on the transmittance of the film by virtue of the proximity of the refractive indices of the additive and of the matrix. As this impact modifier is also not very flammable, the fire resistance of the film remains high.

TABLE 1

| | | | Ductile-to-brittle | |
|---|---|---|---|---|
| | | | transition | |
| | Content of | Transmittance | temperature | Fire |
| Matrix | CS (%) | (%) | (° C.) | resistance |
| PE | 0 | 93 | <−20° C. | M4 |
| PVDF | 0 | 93 | 0° C. | M1 |
| PVDF | 10 | 88 | <−20° C. | M2 |

1. A composition comprising a polyvinylidene fluoride (PVDF) matrix and at least one core-shell impact modifier having a poly(organosiloxane) core and at least one thermoplastic shell, in which the content by weight of impact modifier varies between 2.5% and less than 40%.

2. The composition as claimed in claim 1, in which the content by weight of impact modifier is greater than 5% and less than or equal to 30%.

3. The composition as claimed in claim 1, in which the PVDF matrix is composed of a PVDF homopolymer or of a copolymer prepared by copolymerization of vinylidene fluoride with a fluorinated comonomer selected from the group consisting of: vinyl fluoride; trifluoroethylene; chlorotrifluoroethylene; 1,2-difluoroethylene; tetrafluoroethylene; hexafluoropropylene; perfluoro(alkyl vinyl) ethers; perfluoro(methyl vinyl) ether, perfluoro(ethyl vinyl) ether (PEVE), perfluoro(propyl vinyl) ether; perfluoro(1,3-dioxole); and perfluoro(2,2-dimethyl-1,3-dioxole).

4. The composition as claimed in claim 1, in which said poly(organosiloxane) core comprises one or more groups chosen from alkyl or vinyl radicals comprising between 1 and 18 carbons, aryl radicals and hydrocarbons which are substituted.

5. The composition as claimed in claim 1, in which said core is crosslinked in all or part.

6. The composition as claimed in claim 5, in which the mean degree of functionalization of the core is between 2 and 3.

7. The composition as claimed in claim 1, in which the shell or shells are polymers or copolymers formed of monomers selected from the group consisting of alkyl acrylates, alkyl methacrylates, acrylonitrile, styrene, vinylstyrene, vinyl propionate, maleimide, vinyl chloride, ethylene, butadiene, isoprene and chloroprene.

8. The composition as claimed in claim 7, in which the shell or shells are homopolymers of styrene, an alkylstyrene or methyl methacrylate or copolymers comprising at least 70 mol % of styrene, an alkylstyrene or methyl methacrylate and at least one comonomer chosen from the remaining monomers, another alkyl (meth) acrylate, vinyl acetate and acrylonitrile.

9. The film as claimed in claim 16, having a thickness between 30 and 200 microns.

10. The film as claimed in claim 1, in which the fraction of the core in the impact modifier represents between 0.05 and 90% by weight.

11. The film as claimed in claim 16, wherein said film comprises at least one additive from the group consisting of: matifying agents, infrared reflecting agents, opacifying agents, plasticizers pearlescent pigments.

12. A multilayer film comprising at least one layer of a film (A) as claimed in claim 16 and at least one PVDF layer.

13. The film as claimed in claim 12, consisting of said at least one layer of a film (A) and two external PVDF layers, said external layers having an identical or different structure.

14. The film as claimed in claim 1, wherein said film is a component of an agricultural covering material, or as covering for greenhouses.

15. The film as claimed in claim 1, wherein said film is a material that is a component of a roof and/or façade of a building, wherein said building is selected from the group consisting of agricultural buildings, and livestock buildings.

16. The composition of claim 1, wherein said composition is in the form of a film.

17. The composition as claimed in claim 4, in which said poly(organosiloxane) core comprises one or more groups chosen from alkyl or vinyl radicals comprising between 1 and 6 carbons, aryl radicals and hydrocarbons which are substituted.

18. The film as claimed in claim 9 having a thickness 80 and 150 microns.

19. The composition as claimed in claim 10, in which the fraction of the core in the impact modifier represents between 60 and 80% by weight.
